(19) United States
(12) Patent Application Publication
(10) Pub. No.: US 2026/0292431 A1
(43) Pub. Date: Sep. 24, 2026

(54) A METHOD AND APPARATUS FOR EFFICIENT DELIVERY FOR 6DOF RENDERING

(71) Applicant: Nokia Technologies Oy, Espoo (FI)

(72) Inventors: Sujeet Shyamsundar Mate, Tampere (FI); Jussi Artturi Leppänen, Tampere (FI); Arto Juhani Lehtiniemi, Lempäälä (FI); Antti Johannes Eronen, Tampere (FI)

(21) Appl. No.: 19/475,084

(22) PCT Filed: Apr. 3, 2024
(86) PCT No.: PCT/EP2024/059034

§ 371 Date: Oct. 14, 2025

(30) Foreign Application Priority Data
Apr. 19, 2023 (GB) 2305711.0

(51) Int. Cl. H04S 7/00

(52) U.S. Cl. CPC H04S 7/303; H04S 2420/11

(57) ABSTRACT

A method for generating an audio scene having at least two audio content sets, the method including: obtaining a media description including information identifying positions of audio sources within the audio scene associated with the at least two audio content sets; encoding the at least two audio content sets such that the at least two audio content sets are configured to be output at at least two representation levels; and outputting for the audio scene encoded at least two audio content sets, wherein the output encoded at least two audio content sets includes a first of the encoded at least two audio content sets encoded at a first of the at least two representation levels and a second first of the encoded at least two audio content sets encoded at a second of the at least two representation levels.

### FIELD

The present application relates to apparatus and methods for efficient delivery in 6 degrees of freedom rendering and not specifically with 6 degree of freedom systems of microphone-array captured audio.

### BACKGROUND

MPEG-I Immersive Audio standardization (ISO/IEC 23090-4) is in being refined and new features added. One aspect is to work for efficient delivery of the content required for rendering. Higher order Ambisonics (HOA) is one of the signal types providing significant technologies in the standard. Efficient delivery of content is important for complex scenes with large number of HOA sources.

The HOA audio format is bandwidth intensive due to the high number of channels required to achieve high quality reproduction of the audio scene. For example, a 4th order ambisonics representation consists of 25 channels. MPEG-H 3DA audio supports up to sixth order or 49 channels. For representing an audio scene with six degrees of freedom (6DoF), i.e., HOA translation, multiple HOA sources are required for good quality production.

As a thumb rule, the higher the number of sampling points (i.e., capture positions) for a given user reachable region (or listening space size) of the audio scene, the better the quality of reproduction while performing HOA translation processing compared to sparse sampling points. The number of HOA sources and the HOA source order is decided by the scene creator. Some example audio scenes are as follows:
an audio scene with 9 sampling positions corresponding to 9 HOA sources with 4th order ambisonics results in 225 (a very large number) channels;
an audio scene representation with 3 HOA sources with 4th order ambisonics results in 75 (also a large number) channels.

The above examples highlight the need for methods for efficient delivery for audio scenes comprising multiple HOA sources, the greater the number or order of HOA sources, the greater is the need to efficient delivery.

### SUMMARY

There is provided according to a first aspect a method for generating an audio scene having at least two audio content sets, the method comprising: obtaining a media description comprising information identifying positions of audio sources within the audio scene associated with the at least two audio content sets; encoding the at least two audio content sets such that the at least two audio content sets are configured to be output at at least two representation levels; and outputting for the audio scene encoded at least two audio content sets, wherein the output encoded at least two audio content sets comprises a first of the encoded at least two audio content sets encoded at a first of the at least two representation levels and a second first of the encoded at least two audio content sets encoded at a second of the at least two representation levels.

The at least two audio content sets may comprise at least two higher ambisonics audio sources.

The at least two audio content sets may comprise metadata associated with each of the at least two higher ambisonics audio sources.

The metadata associated with each of the at least two higher higher order ambisonics audio sources may comprise positions within the audio scene.

The media description may further comprise information identifying the at least two representation levels.

The at least two representation levels may comprise at least two from: a full order representation of the at least two audio content sets; a reduced or lower order representation of the at least two audio content sets; and a first order representation of the at least two audio content sets.

The full order representation of the at least two audio content sets may be all channels of the at least two higher higher order ambisonics audio sources. A reduced or lower order representation of the at least two audio content sets may be a selection of channels of the at least two higher higher order ambisonics audio sources. A first order representation of the at least two audio content sets may be a selection of the first four channels of the at least two higher higher order ambisonics audio sources.

Outputting for the audio scene encoded at least two audio content sets may comprise: receiving at least one request with respect to the audio scene, the request identifying a representation level for the at least two audio content sets; selecting the encoded at least two audio content sets at the representation level for the at least two audio content sets identified within the at least one request; and outputting the selected the encoded at least two audio content sets at the representation level for the at least two audio content sets identified within the at least one request.

Obtaining a media description comprising information identifying positions of audio sources within an audio environment associated with the at least two audio content sets may further comprise outputting the media description to an apparatus, wherein the outputting for the audio scene encoded at least two audio content sets may be further to the apparatus.

The apparatus may be a spatial audio player configured to generate the audio scene.

According to a second aspect there is provided a method for generating an audio scene having at least two audio content sets, the method comprising: obtaining a media description comprising information identifying positions of audio sources within the audio scene associated with the at least two audio content sets; obtaining a listener position within the audio scene; determining for the at least two audio content sets a source representation level based on the positions of the audio sources associated with the at least two content sets and the listener position; retrieving encoded at least two audio content sets based on the source representation level, wherein the encoded at least two audio content sets comprises a first of the encoded at least two audio content sets encoded at a first of at least two representation levels and a second of the encoded at least two audio content sets encoded at a second of the at least two representation levels; and generating spatialized audio output based on the retrieved encoded at least two audio content sets.

The at least two representation levels may comprise at least two of: a full order representation of the at least two audio content sets; a reduced or lower order representation of the at least two audio content sets; and a first order representation of the at least two audio content sets.

The media description may further identify an ambisonics order for the at least two audio content sets.

Retrieving encoded at least two audio content sets based on the source representation level may comprise retrieving an encoded all channels representation for the encoded at least two audio content sets when the source representation level is a full order representation.

Retrieving encoded at least two audio content sets based on the source representation level may comprise retrieving an encoded selected channels representation for the encoded at least two audio content sets when the source representation level is a reduced or lower order representation.

Retrieving encoded at least two audio content sets based on the source representation level may comprise retrieving an encoded a first four selected channels representation for the encoded at least two audio content sets when the source representation level is a first order representation.

Generating the spatialized audio output based on the retrieved encoded at least two audio content sets may comprise: performing signal interpolation by processing, channel signals of the retrieved encoded at least two audio content sets based on the listener position; and generating the spatialized audio output based on the performed signal interpolation.

Retrieving encoded at least two audio content sets based on the source representation level may comprise: generating a request for representations of the encoded at least two audio content sets, the request comprising the source representation level; and receiving the requested representations of the encoded at least two audio content sets.

Determining for the at least two audio content sets a source representation level based on the positions of the audio sources associated with the at least two content sets and the listener position may further comprise determining content set rendering related state information associated with the at least two audio content sets, the content set rendering related state information, wherein retrieving encoded at least two audio content sets may comprise retrieving encoded at least at least two audio content sets based on the content set rendering related state information.

The content set rendering related state information configured to identify whether the content set may be be used as one of: a six-degree of freedom higher order ambisonics audio source during generating the spatialized audio output; and a object rendering audio source during generating the spatialized audio output.

According to a third aspect there is provided an apparatus for generating an audio scene having at least two audio content sets, the apparatus comprising means configured to: obtain a media description comprising information identifying positions of audio sources within the audio scene associated with the at least two audio content sets; encode the at least two audio content sets such that the at least two audio content sets are configured to be output at at least two representation levels; and output for the audio scene encoded at least two audio content sets, wherein the output encoded at least two audio content sets comprises a first of the encoded at least two audio content sets encoded at a first of the at least two representation levels and a second first of the encoded at least two audio content sets encoded at a second of the at least two representation levels.

The at least two audio content sets may comprise at least two higher ambisonics audio sources.

The at least two audio content sets may comprise metadata associated with each of the at least two higher ambisonics audio sources.

The metadata associated with each of the at least two higher higher order ambisonics audio sources may comprise positions within the audio scene.

The media description may further comprise information identifying the at least two representation levels.

The at least two representation levels may comprise at least two from: a full order representation of the at least two audio content sets; a reduced or lower order representation of the at least two audio content sets; and a first order representation of the at least two audio content sets.

The full order representation of the at least two audio content sets may be all channels of the at least two higher higher order ambisonics audio sources. A reduced or lower order representation of the at least two audio content sets may be a selection of channels of the at least two higher higher order ambisonics audio sources. A first order representation of the at least two audio content sets may be a selection of the first four channels of the at least two higher higher order ambisonics audio sources.

The means configured to output for the audio scene encoded at least two audio content sets may be configured to: receive at least one request with respect to the audio scene, the request identifying a representation level for the at least two audio content sets; select the encoded at least two audio content sets at the representation level for the at least two audio content sets identified within the at least one request; and output the selected the encoded at least two audio content sets at the representation level for the at least two audio content sets identified within the at least one request.

The means configured to obtain a media description comprising information identifying positions of audio sources within an audio environment associated with the at least two audio content sets may further be configured to output the media description to a further apparatus, wherein the output for the audio scene encoded at least two audio content sets may be to the further apparatus.

The further apparatus may be a spatial audio player configured to generate the audio scene.

According to a fourth aspect there is provided an apparatus for generating an audio scene having at least two audio content sets, the apparatus comprising means configured to: obtain a media description comprising information identifying positions of audio sources within the audio scene associated with the at least two audio content sets; obtain a listener position within the audio scene; determine for the at least two audio content sets a source representation level based on the positions of the audio sources associated with the at least two content sets and the listener position; retrieve encoded at least two audio content sets based on the source representation level, wherein the encoded at least two audio content sets comprises a first of the encoded at least two audio content sets encoded at a first of at least two representation levels and a second of the encoded at least two audio content sets encoded at a second of the at least two representation levels; and generating spatialized audio output based on the retrieved encoded at least two audio content sets.

The at least two representation levels may comprise at least two of: a full order representation of the at least two audio content sets; a reduced or lower order representation of the at least two audio content sets; and a first order representation of the at least two audio content sets.

The media description may further identify an ambisonics order for the at least two audio content sets.

The means configured to retrieve encoded at least two audio content sets based on the source representation level may be configured to retrieve an encoded all channels representation for the encoded at least two audio content sets when the source representation level is a full order representation.

The means configured to retrieve encoded at least two audio content sets based on the source representation level may be configured to retrieve an encoded selected channels representation for the encoded at least two audio content sets when the source representation level is a reduced or lower order representation.

The means configured to retrieve encoded at least two audio content sets based on the source representation level may be configured to retrieve an encoded first four selected channels representation for the encoded at least two audio content sets when the source representation level is a first order representation.

The means configured to generate the spatialized audio output based on the retrieved encoded at least two audio content sets may be configured to: perform signal interpolation by processing, channel signals of the retrieved encoded at least two audio content sets based on the listener position; and generate the spatialized audio output based on the performed signal interpolation.

The means configured to retrieve encoded at least two audio content sets based on the source representation level may be configured to: generate a request for representations of the encoded at least two audio content sets, the request comprising the source representation level; and receive the requested representations of the encoded at least two audio content sets.

The means configured to determine for the at least two audio content sets a source representation level based on the positions of the audio sources associated with the at least two content sets and the listener position may further be configured to determine content set rendering related state information associated with the at least two audio content sets, the content set rendering related state information, wherein the means configured to retrieve encoded at least two audio content sets may be configured to retrieve encoded at least at least two audio content sets based on the content set rendering related state information.

The content set rendering related state information configured to identify whether the content set may be be used as one of: a six-degree of freedom higher order ambisonics audio source during generating the spatialized audio output; and a object rendering audio source during generating the spatialized audio output.

According to a fifth aspect there is provided an apparatus for generating an audio scene having at least two audio content sets, the apparatus comprising at least one processor and at least one memory storing instructions that, when executed by the at least one processor, cause the system at least to perform: obtaining a media description comprising information identifying positions of audio sources within the audio scene associated with the at least two audio content sets; encoding the at least two audio content sets such that the at least two audio content sets are configured to be output at at least two representation levels; and outputting for the audio scene encoded at least two audio content sets, wherein the output encoded at least two audio content sets comprises a first of the encoded at least two audio content sets encoded at a first of the at least two representation levels and a second first of the encoded at least two audio content sets encoded at a second of the at least two representation levels.

The at least two audio content sets may comprise at least two higher ambisonics audio sources.

The at least two audio content sets may comprise metadata associated with each of the at least two higher ambisonics audio sources.

The metadata associated with each of the at least two higher higher order ambisonics audio sources may comprise positions within the audio scene.

The media description may further comprise information identifying the at least two representation levels.

The at least two representation levels may comprise at least two from: a full order representation of the at least two audio content sets; a reduced or lower order representation of the at least two audio content sets; and a first order representation of the at least two audio content sets.

The full order representation of the at least two audio content sets may be all channels of the at least two higher higher order ambisonics audio sources.

A reduced or lower order representation of the at least two audio content sets may be a selection of channels of the at least two higher higher order ambisonics audio sources.

A first order representation of the at least two audio content sets may be a selection of the first four channels of the at least two higher higher order ambisonics audio sources.

The apparatus caused to perform outputting for the audio scene encoded at least two audio content sets may be caused to perform: receiving at least one request with respect to the audio scene, the request identifying a representation level for the at least two audio content sets; selecting the encoded at least two audio content sets at the representation level for the at least two audio content sets identified within the at least one request; and outputting the selected the encoded at least two audio content sets at the representation level for the at least two audio content sets identified within the at least one request.

The apparatus caused to perform obtaining a media description comprising information identifying positions of audio sources within an audio environment associated with the at least two audio content sets may further be caused to perform outputting the media description to a further apparatus, wherein the apparatus may be caused to perform outputting for the audio scene encoded at least two audio content to the further apparatus.

The further apparatus may be a spatial audio player configured to generate the audio scene.

According to a sixth aspect there is provided an apparatus for generating an audio scene having at least two audio content sets, the apparatus comprising at least one processor and at least one memory storing instructions that, when executed by the at least one processor, cause the system at least to perform: obtaining a media description comprising information identifying positions of audio sources within the audio scene associated with the at least two audio content sets; obtaining a listener position within the audio scene; determining for the at least two audio content sets a source representation level based on the positions of the audio sources associated with the at least two content sets and the listener position; retrieving encoded at least two audio content sets based on the source representation level, wherein the encoded at least two audio content sets comprises a first of the encoded at least two audio content sets encoded at a first of at least two representation levels and a second of the encoded at least two audio content sets encoded at a second of the at least two representation levels; and generating spatialized audio output based on the retrieved encoded at least two audio content sets.

The at least two representation levels may comprise at least two of: a full order representation of the at least two audio content sets; a reduced or lower order representation of the at least two audio content sets; and a first order representation of the at least two audio content sets.

The media description may further identify an ambisonics order for the at least two audio content sets.

The means configured to perform retrieving encoded at least two audio content sets based on the source representation level may be caused to perform retrieving an encoded all channels representation for the encoded at least two audio content sets when the source representation level is a full order representation.

The means configured to perform retrieving encoded at least two audio content sets based on the source representation level may be caused to perform retrieving an encoded selected channels representation for the encoded at least two audio content sets when the source representation level is a reduced or lower order representation.

The means configured to perform retrieving encoded at least two audio content sets based on the source representation level may be caused to perform retrieving an encoded a first four selected channels representation for the encoded at least two audio content sets when the source representation level is a first order representation.

The means configured to perform generating the spatialized audio output based on the retrieved encoded at least two audio content sets may be caused to perform: performing signal interpolation by processing, channel signals of the retrieved encoded at least two audio content sets based on the listener position; and generating the spatialized audio output based on the performed signal interpolation.

The means caused to perform retrieving encoded at least two audio content sets based on the source representation level may be caused to further perform: generating a request for representations of the encoded at least two audio content sets, the request comprising the source representation level; and receiving the requested representations of the encoded at least two audio content sets.

The means caused to perform determining for the at least two audio content sets a source representation level based on the positions of the audio sources associated with the at least two content sets and the listener position may further be caused to perform determining content set rendering related state information associated with the at least two audio content sets, the content set rendering related state information, wherein the means configured to perform retrieving encoded at least two audio content sets may further be configured to perform retrieving encoded at least at least two audio content sets based on the content set rendering related state information.

The content set rendering related state information configured to identify whether the content set may be be used as one of: a six-degree of freedom higher order ambisonics audio source during generating the spatialized audio output; and a object rendering audio source during generating the spatialized audio output.

According to a seventh aspect there is provided an apparatus for generating an audio scene having at least two audio content sets, the apparatus comprising: obtaining circuitry configured to obtain a media description comprising information identifying positions of audio sources within the audio scene associated with the at least two audio content sets; encoding circuitry configured to encode the at least two audio content sets such that the at least two audio content sets are configured to be output at at least two representation levels; and outputting circuitry configured to output for the audio scene encoded at least two audio content sets, wherein the output encoded at least two audio content sets comprises a first of the encoded at least two audio content sets encoded at a first of the at least two representation levels and a second first of the encoded at least two audio content sets encoded at a second of the at least two representation levels.

According to an eighth aspect there is provided an apparatus for generating an audio scene having at least two audio content sets, the apparatus comprising: obtaining circuitry configured to obtain a media description comprising information identifying positions of audio sources within the audio scene associated with the at least two audio content sets; obtaining circuitry configured to obtain a listener position within the audio scene; determining circuitry configured to determine for the at least two audio content sets a source representation level based on the positions of the audio sources associated with the at least two content sets and the listener position; retrieving circuitry configured to retrieve encoded at least two audio content sets based on the source representation level, wherein the encoded at least two audio content sets comprises a first of the encoded at least two audio content sets encoded at a first of at least two representation levels and a second of the encoded at least two audio content sets encoded at a second of the at least two representation levels; and generating spatialized audio output based on the retrieved encoded at least two audio content sets.

According to a ninth aspect there is provided a computer program comprising instructions [or a computer readable medium comprising instructions] for causing an apparatus, for generating an audio scene having at least two audio content sets, the apparatus caused to perform at least the following: obtaining a media description comprising information identifying positions of audio sources within the audio scene associated with the at least two audio content sets; encoding the at least two audio content sets such that the at least two audio content sets are configured to be output at at least two representation levels; and outputting for the audio scene encoded at least two audio content sets, wherein the output encoded at least two audio content sets comprises a first of the encoded at least two audio content sets encoded at a first of the at least two representation levels and a second first of the encoded at least two audio content sets encoded at a second of the at least two representation levels.

According to a tenth aspect there is provided a computer program comprising instructions [or a computer readable medium comprising instructions] for causing an apparatus, for generating an audio scene having at least two audio content sets, the apparatus caused to perform at least the following: obtaining a media description comprising information identifying positions of audio sources within the audio scene associated with the at least two audio content sets; obtaining a listener position within the audio scene; determining for the at least two audio content sets a source representation level based on the positions of the audio sources associated with the at least two content sets and the listener position; retrieving encoded at least two audio content sets based on the source representation level, wherein the encoded at least two audio content sets comprises a first of the encoded at least two audio content sets encoded at a first of at least two representation levels and a second of the encoded at least two audio content sets encoded at a second of the at least two representation levels; and generating spatialized audio output based on the retrieved encoded at least two audio content sets.

According to an eleventh aspect there is provided a non-transitory computer readable medium comprising program instructions for causing an apparatus, for generating an audio scene having at least two audio content sets, to perform at least the following: obtaining a media description comprising information identifying positions of audio sources within the audio scene associated with the at least two audio content sets; encoding the at least two audio content sets such that the at least two audio content sets are configured to be output at at least two representation levels; and outputting for the audio scene encoded at least two audio content sets, wherein the output encoded at least two audio content sets comprises a first of the encoded at least two audio content sets encoded at a first of the at least two representation levels and a second first of the encoded at least two audio content sets encoded at a second of the at least two representation levels.

According to a twelfth aspect there is provided a non-transitory computer readable medium comprising program instructions for causing an apparatus, for generating an audio scene having at least two audio content sets, to perform at least the following: obtaining a media description comprising information identifying positions of audio sources within the audio scene associated with the at least two audio content sets; obtaining a listener position within the audio scene; determining for the at least two audio content sets a source representation level based on the positions of the audio sources associated with the at least two content sets and the listener position; retrieving encoded at least two audio content sets based on the source representation level, wherein the encoded at least two audio content sets comprises a first of the encoded at least two audio content sets encoded at a first of at least two representation levels and a second of the encoded at least two audio content sets encoded at a second of the at least two representation levels; and generating spatialized audio output based on the retrieved encoded at least two audio content sets.

According to a thirteenth aspect there is provided an apparatus, for generating an audio scene having at least two audio content sets, the apparatus comprising: means for obtaining a media description comprising information identifying positions of audio sources within the audio scene associated with the at least two audio content sets; means for encoding the at least two audio content sets such that the at least two audio content sets are configured to be output at at least two representation levels; and means for outputting for the audio scene encoded at least two audio content sets, wherein the output encoded at least two audio content sets comprises a first of the encoded at least two audio content sets encoded at a first of the at least two representation levels and a second first of the encoded at least two audio content sets encoded at a second of the at least two representation levels.

According to a fourteenth aspect there is provided an apparatus, for generating an audio scene having at least two audio content sets, the apparatus comprising: means for obtaining a media description comprising information identifying positions of audio sources within the audio scene associated with the at least two audio content sets; means for obtaining a listener position within the audio scene; means for determining for the at least two audio content sets a source representation level based on the positions of the audio sources associated with the at least two content sets and the listener position; means for retrieving encoded at least two audio content sets based on the source representation level, wherein the encoded at least two audio content sets comprises a first of the encoded at least two audio content sets encoded at a first of at least two representation levels and a second of the encoded at least two audio content sets encoded at a second of the at least two representation levels; and generating spatialized audio output based on the retrieved encoded at least two audio content sets.

According to a fifteenth aspect there is provided a computer readable medium comprising instructions for causing an apparatus, for generating an audio scene having at least two audio content sets, to perform at least the following: obtaining a media description comprising information identifying positions of audio sources within the audio scene associated with the at least two audio content sets; encoding the at least two audio content sets such that the at least two audio content sets are configured to be output at at least two representation levels; and outputting for the audio scene encoded at least two audio content sets, wherein the output encoded at least two audio content sets comprises a first of the encoded at least two audio content sets encoded at a first of the at least two representation levels and a second first of the encoded at least two audio content sets encoded at a second of the at least two representation levels.

According to a fifteenth aspect there is provided a computer readable medium comprising instructions for causing an apparatus, for generating an audio scene having at least two audio content sets, to perform at least the following: obtaining a media description comprising information identifying positions of audio sources within the audio scene associated with the at least two audio content sets; obtaining a listener position within the audio scene; determining for the at least two audio content sets a source representation level based on the positions of the audio sources associated with the at least two content sets and the listener position; retrieving encoded at least two audio content sets based on the source representation level, wherein the encoded at least two audio content sets comprises a first of the encoded at least two audio content sets encoded at a first of at least two representation levels and a second of the encoded at least two audio content sets encoded at a second of the at least two representation levels; and generating spatialized audio output based on the retrieved encoded at least two audio content sets.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically an example 6DoF audio scene, showing a listener position trajectory within the audio scene comprising 8 HOA sources and change in HOA sources needed for rendering the audio;

FIGS. 2 and 3 show schematically example listener position dependent HOA audio data retrieval requirements based on the audio scene shown in FIG. 1;

FIGS. 4 and 5 show the channels for HOA sources for the baseline and sub-set channel selection based on the role of HOA sources based on listener position in an audio scene, where FIG. 4 indicates a HOA source for which all channels are processed and FIG. 5 indicates a HOA source for which only the first four channels are processed;

FIGS. 6a to 6c show example channel retrieval for HOA sources during the temporal duration ΔT₁ based on the audio scene shown in FIG. 1, where HOA₁ is used for signal interpolation while HOA₂ and HOA₃ is used for spatial metadata processing;

FIG. 7 shows an example encoding process according to some embodiments;

FIG. 8 shows a flow diagram of the operations of the example encoder according to some embodiments;

FIG. 9 shows a flow diagram of the operations of an example decoder or renderer according to some embodiments;

FIGS. 10 and 11 show example baseline and enhanced decoders according to some embodiments;

FIG. 12 shows channel selection for HOA sources based on the audio scene shown in FIG. 1 according to some embodiments;

FIG. 13 shows example channel retrieval for HOA sources during the temporal duration ΔT₁ based on the audio scene shown in FIG. 1;

FIGS. 14 and 15 show example implementations according to some embodiments;

FIG. 16 shows an example effect of implementations of some embodiments; and

FIG. 17 shows an example apparatus suitable for implementing some embodiments.

### EMBODIMENTS OF THE APPLICATION

The concept as discussed herein in further detail with respect to the following embodiments is related to apparatus and methods for minimizing bitrates on a player device for 6DoF HOA rendering.

A higher order HOA source (which has a large number of audio channels per HOA source) needs higher encoding bitrates. However a higher order HOA source is often required to represent an audio scene with more detailed spatial audio cues and high subjective quality audio. Whilst it is possible to reduce the bitrate by encoding all HOA signals as (First Order Ambisonics) FOA audio signals this leads to poorer audio quality with respect to spatial localization for a user.

Retrieving and consuming all of the HOA source signals encoded at a higher order requires a much higher bitrate because multiple higher order HOA source signals are required for performing 6DoF rendering. Thus, with an increase in the encoding bitrate of one HOA source, for 6DoF rendering, where in a steady scenario where the listener position is within a triangle formed by three HOA sources, there is at least a threefold increase in the corresponding bandwidth requirement. Such a large increase in bandwidth requirement for 6DoF rendering can lead to network congestion and delay. This increases the challenges for consumption of 6DoF rendering of audio scenes comprising multiple higher order HOA sources. In some less common or transient scenarios, audio data from five or six HOA sources may be required in order to ensure smooth listener transition across triangles formed by HOA sources or in case of a teleport involving a sudden long distance jump in the audio scene.

Current 6DoF HOA rendering processes utilize HOA sources differently depending on the listener position:
1. For some HOA sources, all channels are required.
2. For some HOA sources, only a subset of channels is required
3. For some HOA sources, none of the channels are required. In other words, these HOA sources are not required to perform 6DoF HOA rendering due to the current listener position in the audio scene.

Thus, depending on the listener position, some HOA sources are not required (point 3), some HOA source is required at the highest available order (point 1) and some HOA sources are required at lower order or as FOA (point 2).

However, none of the known approaches address delivery of relevant subsets of audio channels from the relevant subset of HOA sources. In other words, none of the known approaches perform the delivery of only the required data without adversely impacting audio quality. This can result in excessive and avoidable bandwidth consumption.

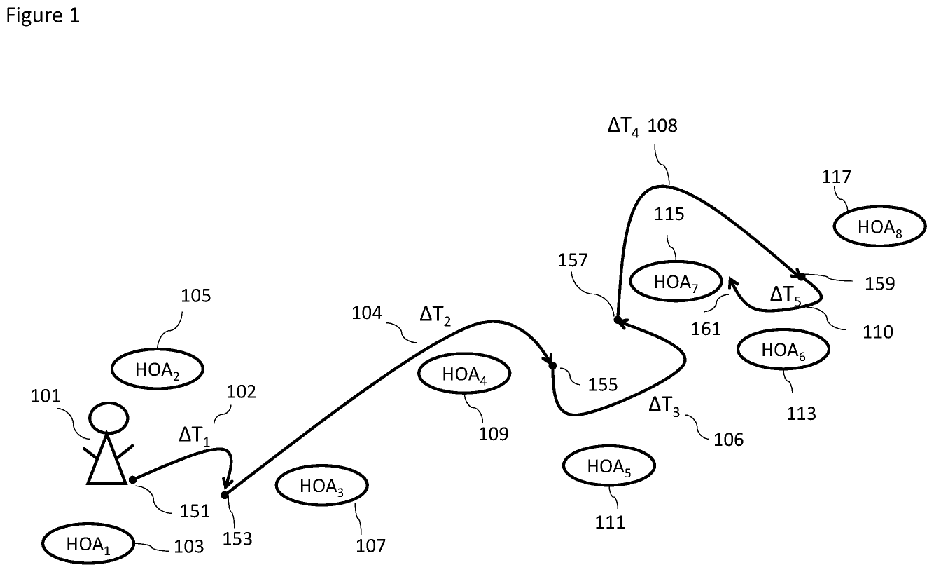

With respect to FIG. 1 is shown an example 6DoF audio scene. Within the scene are located a number of HOA audio sources, these are shown as HOA₁ 103, HOA₂ 105, HOA₃ 107, HOA₄ 109, HOA₅ 111, HOA₆ 113, HOA₇ 115, and HOA₈ 117.

Furthermore is shown in the audio scene a representation of a listener or user 101 as they move through the audio scene. This movement is shown by the line which starts at 151 and ends at 161. The start point 151 is located between and near the HOA sources HOA₁ 103, HOA₂ 105. The movement then for a first time ΔT₁ 102 moves the listener to point 153 closer to HOA₃ 107. Further the movement within the scene for the next time ΔT₂ 104 moves the listener past HOA₃ 107 and around HOA₄ 109 to point 155. Additionally the movement within the scene for the next time ΔT₃ 106 moves the listener towards HOA₅ 111 and then away from the HOA₅ 111 towards HOA₇ 115 to point 157. Further the movement within the scene for the next time ΔT₄ 108 moves the listener around HOA₇ 115 and between HOA₆ 113, HOA₇ 115, and HOA₈ 117 to point 157. Finally with respect to FIG. 1 the movement within the scene for the next time ΔT₅ 110 moves the listener towards HOA₇ 115 to point 161.

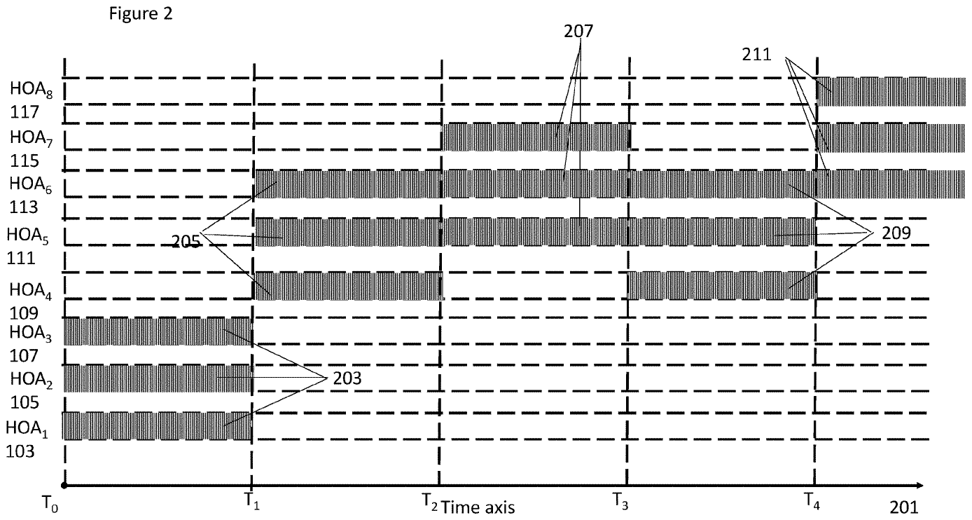

With respect to FIG. 2 is shown an example HOA selection for rendering with respect to the movement as shown in FIG. 1. Thus:
for the time between T₀ and T₁ in other words ΔT₁ the rendering selects the HOA audio sources HOA₁ 103, HOA₂ 105, HOA₃ 107 as these are the closest ones and would contribute the most to the output;
for the time between T₁ and T₂ in other words ΔT₂ the rendering selects the HOA audio sources HOA₄ 109, HOA₅ 111, HOA₆ 113 as these are the closest ones and would contribute the most to the output;
for the time between T₂ and T₃ in other words ΔT₃ the rendering selects the HOA audio sources HOA₅ 111, HOA₆ 113, HOA₇ 115 as the significant contributors;
for the time between T₃ and T₄ in other words ΔT₄ the rendering selects the HOA audio sources HOA₄ 109, HOA₅ 111, HOA₆ 113 for the output; and
for the time between T₄ and T₅ in other words ΔT₅ the rendering selects the HOA audio sources HOA₆ 113, HOA₇ 115, and HOA₈ 117.

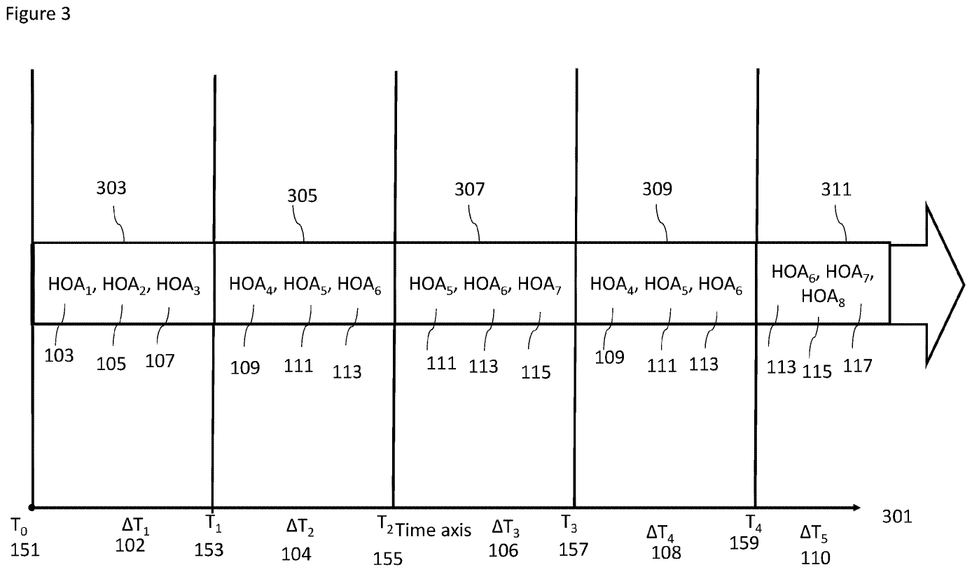

With respect to FIG. 3 is shown an example system wherein the selected HOA audio sources are the only HOA audio signals retrieved, rather retrieving all of the HOA source audio signals. Thus as shown in FIG. 3:
for the time between T₀ 151 and T₁ 153 in other words ΔT₁ 102 the rendering retrieves 303 the HOA audio sources HOA₁ 103, HOA₂ 105, HOA₃ 107;
for the time between T₁ 153 and T₂ 155 in other words ΔT₂ 104 the rendering retrieves 305 the HOA audio sources HOA₄ 109, HOA₅ 111, HOA₆ 113;
for the time between T₂ 155 and T₃ 157 in other words ΔT₃ 106 the rendering retrieves 307 the HOA audio sources HOA₅ 111, HOA₆ 113, HOA₇ 115;
for the time between T₃ 157 and T₄ 159 in other words ΔT₄ 108 the rendering retrieves 309 the HOA audio sources HOA₄ 109, HOA₅ 111, HOA₆ 113; and
for the time between T₄ 159 and T₅ 161 other words ΔT₅ 110 the rendering retrieves 311 the HOA audio sources HOA₆ 113, HOA₇ 115, and HOA₈ 117.

Thus for example as discussed in the following examples, in some situations the number of channels for the HOA sources which are selected/retrieved can be changed. For example the number of channels (or the HOA order representation) for the selected HOA sources can be selected by the player depending on the listener position.

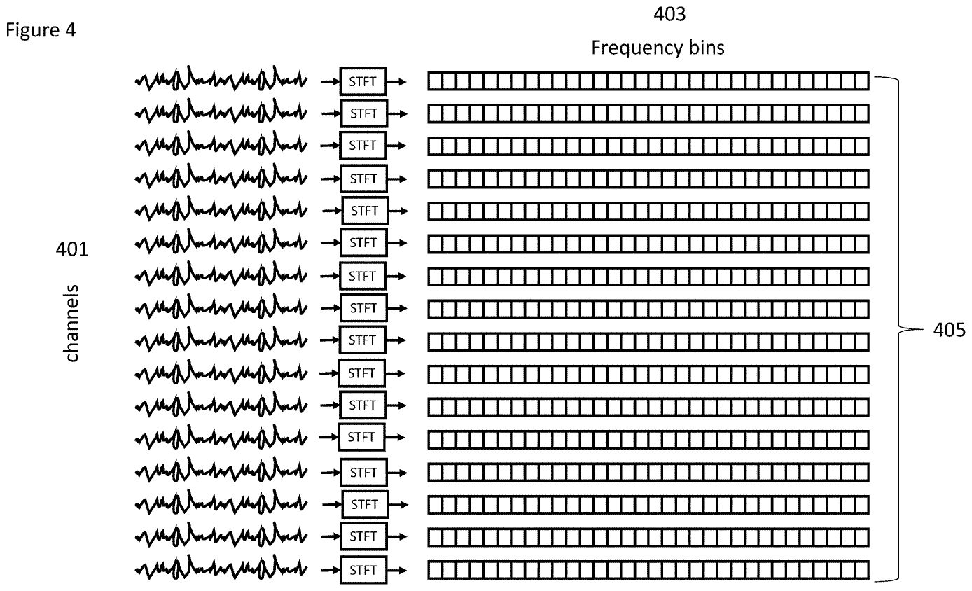

For example as shown in FIG. 4 a first HOA type audio signals can be retrieved where the full set 405 of channels 401 are retrieved and STFT processing is performed for frequency bins 403 for all the retrieved channels.

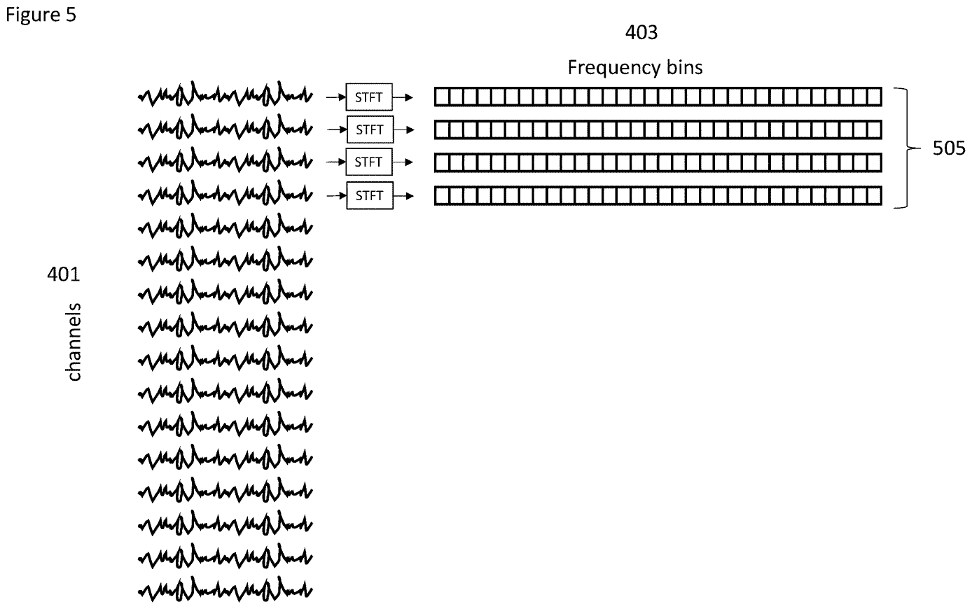

Additionally as shown in FIG. 5 a further HOA type audio signals can be retrieved where a full set 505 of channels 401 are retrieved and STFT processing is performed for frequency bins 403 for a subset (first four or first HOA order) of all the retrieved channels.

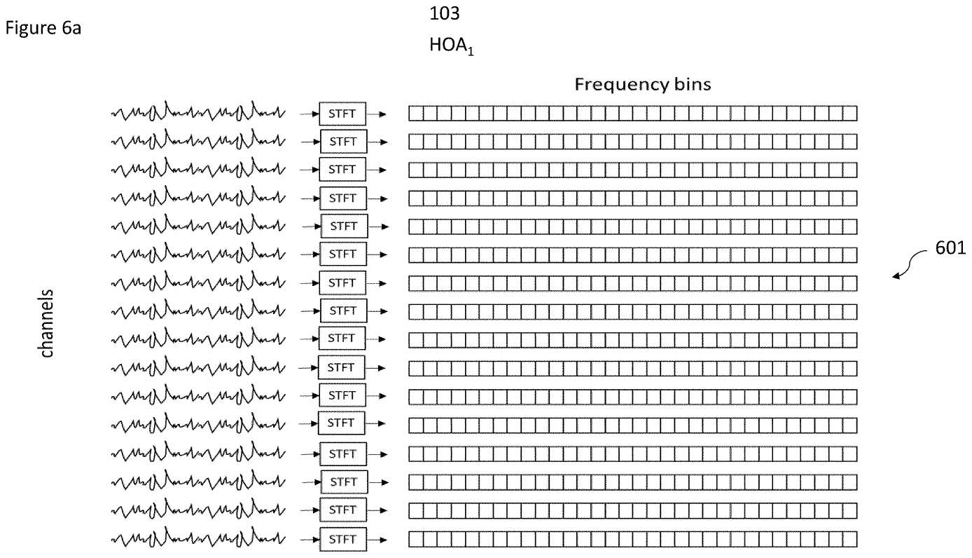

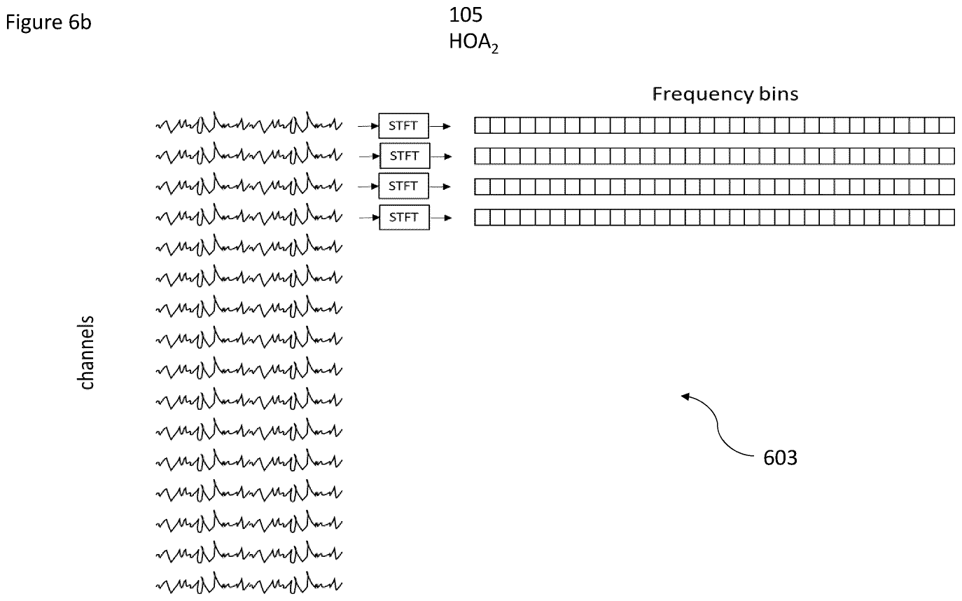

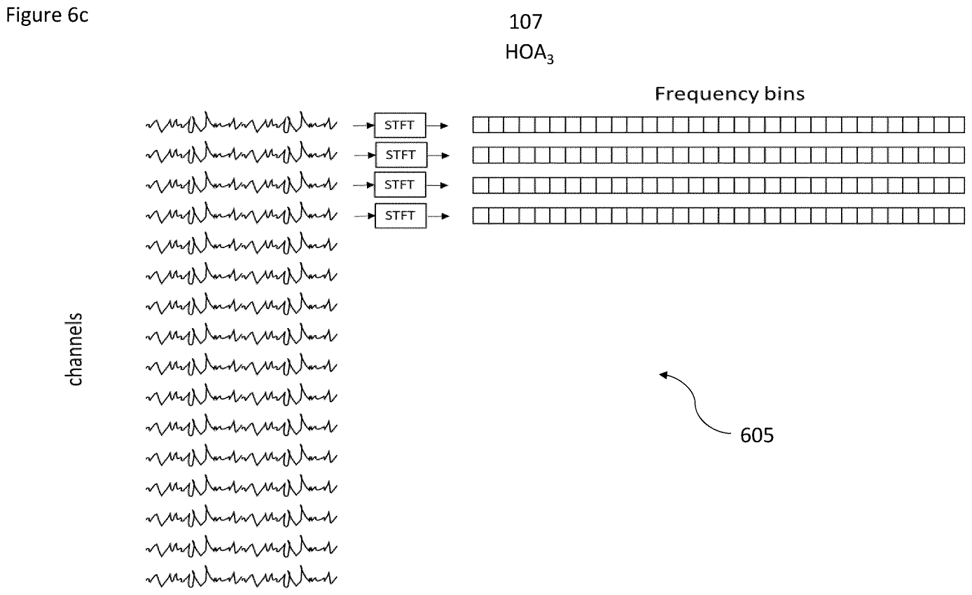

Thus with respect to FIGS. 6a to 6c are shown an example of the audio sources that are encoded/retrieved when a listener is in the audio scene as shown in FIG. 1 when the for the time between T₀ 151 and T₁ 153 in other words ΔT₁ 102. In this example is shown where the HOA audio source HOA₁ 103 has the full set 601 of channels retrieved and STFT performed for the frequency bins whereas where the HOA audio source HOA₂ 105 has the sub-set 603 of channels and frequency bins and the HOA audio source HOA₃ 107 has the sub-set 605 of channels and frequency bins.

In some situation the sub-set 603, 605 of channels and frequency bins corresponds to the first order Ambisonics channels (i.e. first four channels).

The concept as discussed herein within the examples and embodiments is one in which there is an apparatus and method for minimizing bitrate on a player device for 6DoF HOA rendering. In such embodiments this is provided by the apparatus and methods for determination of the relevant HOA source representation level (full order, first order) to achieve a reduction (for example 55% in case of higher orders, subject to encoding bitrates) in the bandwidth consumption by performing retrieval of the HOA source(s) used for signal interpolation at the full HOA order representation and retrieval of the HOA sources used for spatial metadata processing at the first HOA order representation. This processing comprises content creation, content description for retrieval and content retrieval enhancements.

This can be implemented in some embodiments by an encoder configured to:
Encode at least a first order ambisonics representation for the HOA sources comprising the audio scene, in addition to the full order representation;
Create a media manifest file that declares all the HOA sources audio data comprising the HOA source position, HOA source order and HOA source position, where each of the HOA source is represented at the highest order specified by the audio scene description encoder input format and at the first order ambisonics representation.

In some embodiments, the full order is highest order HOA source audio data representation made available by the content creator.

Furthermore a decoder/player can be configured to:
Retrieve the media manifest file to determine the HOA source positions;
Obtain the listener position in the audio scene;
Determine the HOA sources to be retrieved based on listener position and HOA source positions;
Determine the HOA source representation level where at least one HOA source is required at full order representation and where at least one HOA source is required at the first order representation (considering the scenario of two HOA source scene, one HOA source is retrieved at full order for signal interpolation whereas one HOA source is retrieved at first order;
Retrieve the HOA sources at highest order in the manifest file if the full order representation is required for rendering; and
Retrieve the HOA sources at the first order if the first order representation is sufficient.

In some embodiments a renderer state interface is provided to the player which comprises a list of HOA sources identifiers, HOA source role for rendering. In another embodiment, the HOA source role may be replaced by HOA source order or number of HOA channels required for 6DoF rendering.

In such a manner the decoder/player can be configured to retrieve only the necessary HOA source audio data and aim to achieve savings of greater than 60% (for example, in case of scenes comprising sixth order HOA sources) with respect to channel data to be retrieved. This can translate to retrieving one HOA source at full order and two HOA sources at first order.

The embodiments as discussed herein can be separated into two parts:
An encoder configured to implement content creation, manifest creation;
A decoder/Player configured to implement a renderer state interface to the player and media retrieval logic

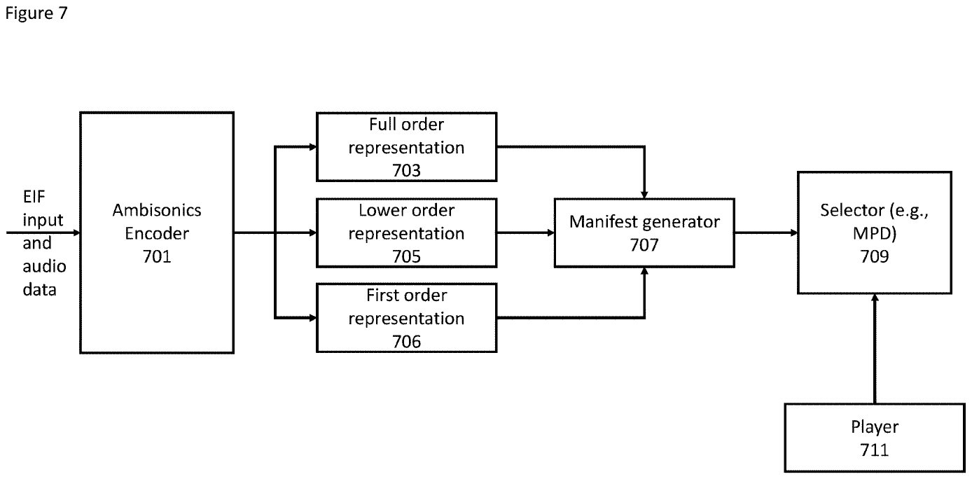

With respect to FIG. 7 is shown an example content creation and manifest creation to achieve efficient bandwidth utilization (and that aims to avoid retrieval of HOA source channels that are not required for render processing without causing any negative impact on the subjective audio quality compared to retrieval of all HOA sources at full order) is shown. The encoder is configured to create appropriately encoded versions of the HOA sources described in the audio scene which is followed by defining extension of media manifest for (e.g., for MPEG DASH, HLS, etc.) retrieval to enable content selection by the player.

In some embodiments the encoder comprises an EIF input which is passed to a Ambisonics encoder 701. The (higher order) Ambisonics encoder 701, generates plurality of HOA source representations comprising at least a full order representation and a first order representation. In some scenarios, the lowest order may be higher than first order.

The (higher order) Ambisonics encoder 701 is configured to receive the encoder input format representation (EIF) and audio data (e.g., audio data corresponding to HOA sources) of the audio scene. In different implementation embodiments, any other suitable scene description format can be used. The EIF is parsed to determine the presence of HOA group structure in the EIF which indicates the presence of HOA sources that are to be used for performing 6DoF HOA rendering.

The HOA source audio data after encoding is available as a full order representation 703.

The encoder is configured to encode the HOA sources at the highest required order using a suitable encoder (for example the MPEG-H 3DA (ISO/IEC 23008-3) encoder) to generate MPEG-H 3DA encoded HOA source audio data with full order (i.e. all channels specified in the EIF).

Subsequently, the HOA sources are encoded as first order representation 706 and any lower order representation 705 with the MPEG-H 3DA encoder. The MPEG-H 3DA encoded full order, first order and lower order HOA source audio data representation is generated. In addition the manifest generator 707 is configured to create a manifest file which is used by a media selector 709. The manifest file can therefore be passed to the selector 709. This may also be referred to as media description file to facilitate appropriate appropriate content selection and retrieval.

Furthermore the MPEG-H 3DA encoded full order representation 703, lower order representation 705 and first order representation 706 of the HOA source audio data are represented in the MPEG DASH MPD generated by the manifest generator 707 and is discussed in further detail below. It should be noted that any other variant of media manifest representation can be generated which enables retrieval of HOA sources at the full order representation carrying all the channels as well as first order representation carrying the first four channels. Following are example operation steps for generating suitable HOA source content for 6DoF rendering according to some embodiments.

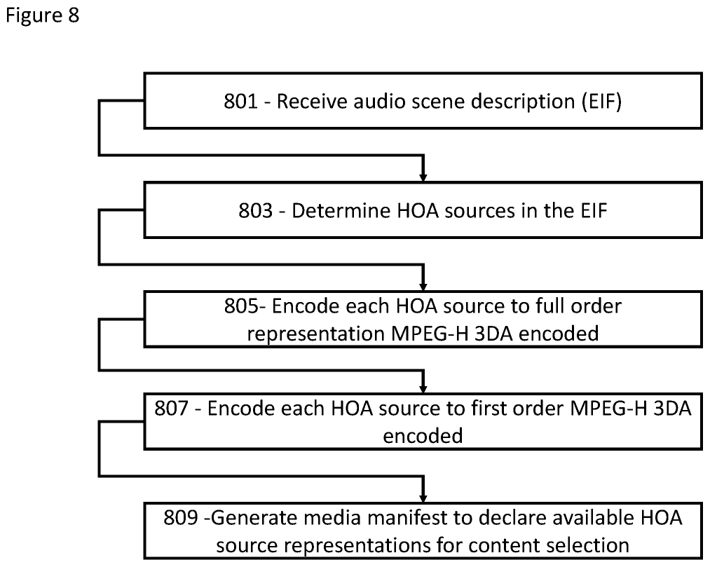

With respect to FIG. 8 is shown an example flow diagram showing the operation of the encoder according to some embodiments.

The initial operation is shown in FIG. 8 by 801, receiving audio scene description (EIF).

Then as shown in FIG. 8 by 803, determining HOA sources in the EIF.

After this as shown in FIG. 8 by 805, encoding each HOA source to full order representation MPEG-H 3DA encoded.

Following this as shown in FIG. 8 by 807 encoding each HOA source to first order MPEG-H 3DA encoded.

Finally as shown in FIG. 8 by 809, generating media manifest to declare available HOA source representations for content selection.

In some embodiments the HOA source information can be derived from the EIF or any other suitable scene description.

```
aligned(8) HOASourceInfoStruct( ){
  HOASourcePositionStruct( ); //position of the HOA source
  unsigned int(16) hoa_source_id; //unique identifier for each HOA
source
  unsigned int(3) full_hoa_order; //highest order of HOA source
  bit (4) reserved = 0;
  unsigned int(1) hoa_group_id_present; //Unique HOA group
identifier
  if(hoa_group_id_present)
    unsigned int(16) hoa_group_id; //Unique HOA group identifier
}
```

The hoa_source_id is the unique identifier for each HOA source in the audio scene.
The full_hoa_order is the highest HOA order available for the HOA source with the hoa_source_id identifier.
The hoa_group_id corresponds to the HOAGroup ID as described in the audio scene. If hoa_group_id present is equal to 0, the HOA source is not part of any HOA group and not expected to be rendered with listener six degrees of freedom.

```
aligned(8) HOASourcePositionStruct( ){
  signed int(32) hoa_source_pos_x;
  signed int(32) hoa_source_pos_y;
  signed int(32) hoa_source_pos_z;
  signed int(16) hoa_source_rot_yaw;
  signed int(16) hoa_source_rot_pitch;
  signed int(16) hoa_source_rot_roll;
}
```

The values of hoa_source_pos_x, hoa_source_pos_y, hoa_source_pos_z define the position with units 1 millimeter in 3D space. The hoa_source_rot_yaw and hoa_source_rot_roll are defined in the units of 2⁻¹⁶ degrees ranging from −180*2¹⁶ to +180*2¹⁶−1 and for hoa_source_rot_pitch from −90*2¹⁶ to 90*2¹⁶−1. In a general sense, it is 2⁻¹⁶ degree step_size in the range of −180 to 180-step_size for yaw and roll, −90 to 90-step_size for pitch.

With respect to the manifest creation for media retrieval, in DASH MPD, a HOA source element with a @schemeIdUri attribute equal to “urn:mpeg:mpegI:mia:2023:6dho” is referred to as a HOA source (6DHO) descriptor. 6DHO descriptors may be present at adaptation set level and no 6DHO descriptor shall be present at any other level. When no Adaptation Set in the Media Presentation contains a 6DHO descriptor, the Media Presentation is inferred to not support 6DoF rendering with HOA sources. The 6DHO descriptor indicates the HOA source the Adaptation Set belongs to. The 6DHO descriptor can therefore include an @value attribute and a HOASourceInfo element with its sub-elements and attributes as specified in the table below.

| Elements and attributes for | | | |
|---|---|---|---|
| 6DHO descriptor | Use | Data type | Description |
| @value | M | xs:string | Specifies the HOA source ID of the HOA |
| | | | source as described in the audio scene |
| | | | description. |
| HOASourceInfo | 1 | | Container element whose sub-elements |
| | | | and attributes provide information about |
| | | | the HOA source. |
| HOASourceInfo@label | O | xs:string | This attribute specifies a string that |
| | | | provides human readable label for the |
| | | | HOA source. |
| HOASourceInfo.Position | 1 | | The attributes of this element specify the |
| | | | position information for the HOA source. |
| HOASourceInfo.Position@x | 1 | xs:int | Specifies the X coordinate of the position |
| | | | of the HOA source in units of 10-1 |
| | | | millimitres in 3D coordinate system of |
| | | | the audio scene. |
| HOASourceInfo.Position@y | 1 | xs:int | Specifies the Y coordinate of the position |
| | | | of the HOA source in units of 10-1 |
| | | | millimitres in 3D coordinate system of |
| | | | the audio scene. |
| HOASourceInfo.Position@z | 1 | xs:int | Specifies the Z coordinate of the position |
| | | | of the HOA source in units of 10-1 |
| | | | millimitres in 3D coordinate system of |
| | | | the audio scene. |
| HOASourceInfo.HOAGroup | 0 . . . 1 | | The attributes of this element specifies |
| | | | the identifier of the HOA Group to which |
| | | | this HOA source belongs to. |
| | | | If this is not present, all the HOA sources |
| | | | in the Media Presentation manifest |
| | | | (MPD) belong to the same HOA group. |
| HOASourceInfo.HOAGroup | 1 | Xs:unsignedBytes | This attribute specifies the identifier of |
| @hoa_group_id | | | the HOA group to which this HOA source |
| | | | belongs to. |

An additional SupplementalProperty or EssentialProperty 6DoFHOAorder descriptor with schemeIdUri equal to “urn:mpeg:mpegI:mia:2023:hord” is referred to as HOAOrder descriptor. This 6DoFHOAorder descriptor is present for every representation of a HOA source adaptation set to indicate the HOA order of the representation.

The presence of different representations of a HOA source comprising an audio scene enables the 6DoF player to retrieve the appropriate HOA source representation as required for efficient retrieval while retaining optimal 6DoF HOA rendering quality.

```
<MPD>
...
...
...
/*This is HOA source ID 3000 in HOA group with ID 1*/
<AdaptationSet id=″3000″ mimeType=″audio/mp4 profiles=′mhm2′″
codecs=″oabl″ segmentAlignment=″1″>
  <HOASource schemeIdUri=″urn:mpeg:mpegI:mia:2023:6dho″ value=″1″>
    <HOASourceInfo label=″HOA Source 1″>
    <Position x=″1″ y=″2″ z=″3″/>
    <HOAGroupInfo groupId=″1″/>
    </HOASourceInfo>
  </HOASource>
  <Representation id=″3001″ bandwidth=″1512000″ startWithSAP=″1″>
  <SupplementalProperty schemeIdUri=″urn:mpeg:mpegI:mia:2023:hord“
hoa_order=4 />
    <SegmentTemplate
media=″AudioScene1.HOASource1.Order4.$Number$.mp4″
initialization=″AudioScene1.HOASource1.Order4.init.mp4″ duration=″17″
startNumber=″1″ timescale=″30″/>
  </Representation>
  <Representation id=″3002″ bandwidth=″256000″ startWithSAP=″1″>
  <SupplementalProperty schemeIdUri=″urn:mpeg:mpegI:mia:2023:hord“
hoa_order=1 />
    <SegmentTemplate
media=″AudioScene1.HOASource1.Order4.$Number$.mp4″
initialization=″AudioScene1.HOASource1.Order4.init.mp4″ duration=″17″
startNumber=″1″ timescale=″30″/>
  </Representation>
</AdaptationSet>
/*This is HOA source ID 4000 in HOA group with ID 1*/
<AdaptationSet id=″4000″ mimeType=″audio/mp4 profiles=′mhm2′″
codecs=″oabl″ segmentAlignment=″2″>
  <HOASource schemeIdUri=″urn:mpeg:mpegI:mia:2023:6dho″ value=″1″>
    <HOASourceInfo label=″HOA Source 1″>
    <Position x=″4″ y=″2″ z=″6″/>
    <HOAGroupInfo groupId=″1″/>
    </HOASourceInfo>
  </HOASource>
  <Representation id=″4001″ bandwidth=″1512000″ startWithSAP=″1″>
  <SupplementalProperty schemeIdUri=″urn:mpeg:mpegI:mia:2023:hord“
hoa_order=4 />
    <SegmentTemplate
media=″AudioScene1.HOASource1.Order4.$Number$.mp4″
initialization=″AudioScene1.HOASource1.Order4.init.mp4″ duration=″17″
startNumber=″1″ timescale=″30″/>
  </Representation>
  <Representation id=″4002″ bandwidth=″256000″ startWithSAP=″1″>
  <SupplementalProperty schemeIdUri=″urn:mpeg:mpegI:mia:2023:hord“
hoa_order=1 />
    <SegmentTemplate
media=″AudioScene1.HOASource1.Order4.$Number$.mp4″
initialization=″AudioScene1.HOASource1.Order4.init.mp4″ duration=″17″
startNumber=″1″ timescale=″30″/>
  </Representation>
</AdaptationSet>
/*This is HOA source ID 5000 in HOA group with ID 1*/
<AdaptationSet id=″5000″ mimeType=″audio/mp4 profiles=′mhm2′″
codecs=″oabl″ segmentAlignment=″1″>
  <HOASource schemeIdUri=″urn:mpeg:mpegI:mia:2023:6dho″ value=″1″>
    <HOASourceInfo label=″HOA Source 1″>
    <Position x=″10″ y=″3″ z=″20″/>
    <HOAGroupInfo groupId=″1″/>
    </HOASourceInfo>
  </HOASource>
  <Representation id=″5001″ bandwidth=″1512000″ startWithSAP=″1″>
  <SupplementalProperty schemeIdUri=″urn:mpeg:mpegI:mia:2023:hord“
hoa_order=4 />
    <SegmentTemplate
media=″AudioScene1.HOASource1.Order4.$Number$.mp4″
initialization=″AudioScene1.HOASource1.Order4.init.mp4″ duration=″17″
startNumber=″1″ timescale=″30″/>
  </Representation>
  <Representation id=″5002″ bandwidth=″256000″ startWithSAP=″1″>
  <SupplementalProperty schemeIdUri=″urn:mpeg:mpegI:mia:2023:hord“
hoa_order=1 />
    <SegmentTemplate
media=″AudioScene1.HOASource1.Order4.$Number$.mp4″
initialization=″AudioScene1.HOASource1.Order4.init.mp4″ duration=″17″
startNumber=″1″ timescale=″30″/>
  </Representation>
</AdaptationSet>
</MPD>
```

The above example DASH manifest enables a DASH player to retrieve the necessary HOA source audio data in an efficient manner (without wastage of retrieving excess channels).

The decoder/players comprises two main components. The first component is the renderer state interface to the player. The second is the media retrieval logic to achieve efficient retrieval.

With respect to the player/decoder parts as shown by FIG. 7 is the selector (for example implemented as part of the MPD) 709, which is configured to perform content selection. The content selection can in some embodiments be based on the listener position.

Furthermore as shown in FIG. 7 the selector 709 can receive listener position information from the player 711 and further more receive the representations as selected by the selector 709.

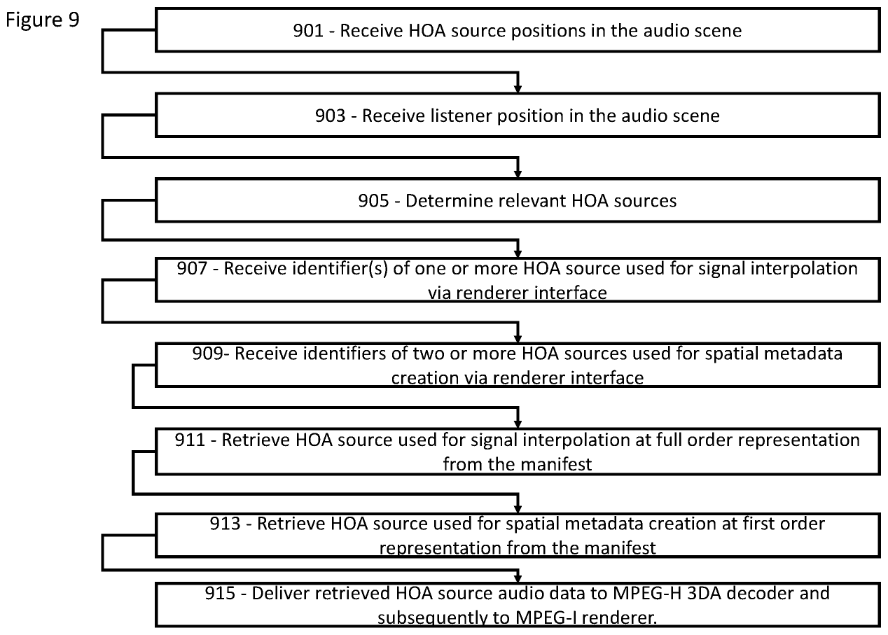

With respect to FIG. 9 is shown the operations of the selector 709/player 711 according to some embodiments following the operations of the encoder as shown in FIG. 8.

Thus for example as shown by 901, is the operation receiving HOA source positions in the audio scene.

Then as shown by 903 is receiving a listener position in the audio scene.

Following this is shown by 905, determining relevant HOA sources.

Then is shown by 907, receiving identifier(s) of one or more HOA source used for signal interpolation via renderer interface.

After this is shown by 909, receive identifiers of two or more HOA sources used for spatial metadata creation via renderer interface.

Then is shown by 911, retrieving the HOA source used for signal interpolation at full order representation from the manifest.

Following this is shown by 913, retrieving HOA source used for spatial metadata creation at first order representation from the manifest.

Finally is shown by 915, deliver retrieved HOA source audio data to MPEG-H 3DA decoder and subsequently to MPEG-I renderer for example implemented in the player 711.

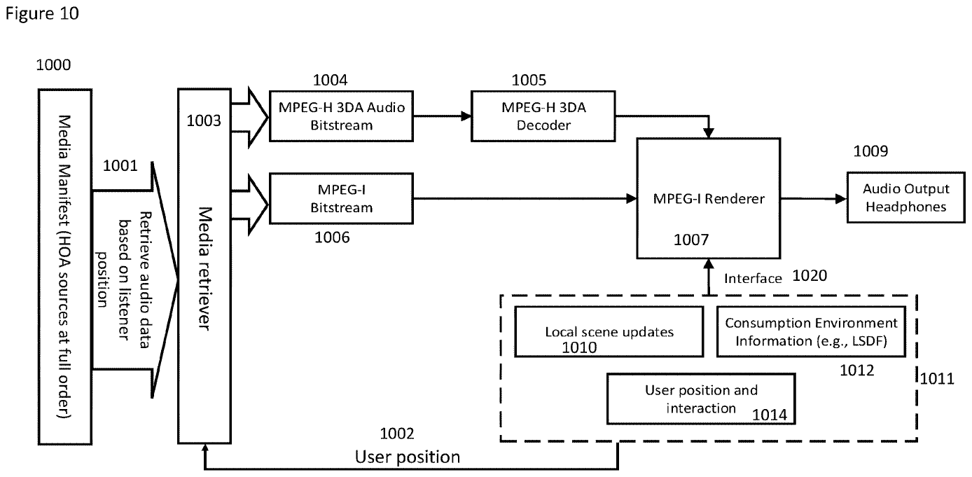

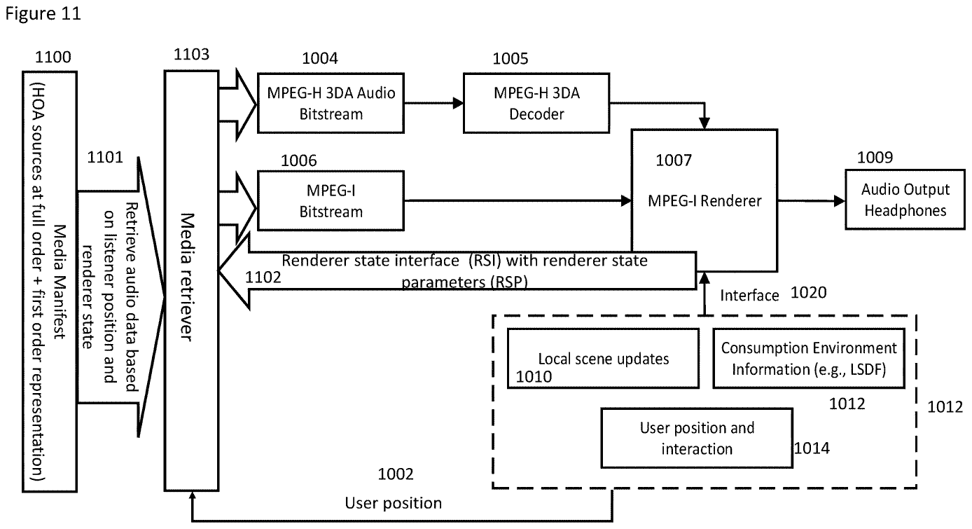

This is further shown in FIGS. 10 and 11 which show the media retriever operations according to some embodiments.

Thus as shown is the baseline media manifest 1000 store which is configured to pass to the decoder/player media retriever 1003 the retrieved audio data based on listener position 1001.

The media retriever 1003 is configured to retrieve the MPEG-H 3DA audio bitstream 1004 and pass this to the MPEG-H 3DA decoder 1005.

The MPEG-H 3DA decoder 1005 is configured to pass the decoder MPEG-H 3DA data to the MPEG-I renderer 1007.

Additionally is shown the retrieved MPEG-I bitstream 1006 which is passed to the MPEG-I renderer 1007.

Furthermore there is an interface 1020 from the player control 1011 to the MPEG-I renderer 1007.

The MPEG-I renderer 1007 is configured to generate audio signals and pass this to the audio output headphones 1009.

Furthermore the player control 1011 can comprise local scene updates 1010, consumption environment information (e.g. LSDF) 1012 and user position and interaction 1014 information. The user position 1002 can be be passed to the media retriever 1002.

Additionally as shown in FIG. 11, and different from FIG. 10 is that the enhanced media manifest 1100 which can comprise HOA sources at full order and first order representation.

Furthermore the media retriever 1103 can be configured to receive renderer state interface (RSI) with renderer state parameters (RSP) 1103.

The media retriever 1103 can furthermore be configured to retrieve 1101 from the media manifest 1100 audio data based on the listener position and the renderer state.

In some embodiments the renderer interface (which is provided from the renderer in MPEG-I Immersive audio) is defined to retrieve information from the bitstream, dynamic updates from a local interface, listener position, listener interaction, LSDF (Listener Space Description Format) file, among others.

The media retrieval is therefore as discussed above performed by the player based on the media manifest describing the content selection options for the audio scene being consumed. This comprises HOA sources representations at full HOA order (as specified in the EIF). The relevant HOA sources are retrieved based on the listener position.

The Renderer State Interface 1102 or RSI is configured to enable the player to obtain the information about various renderer state parameters. The renderer state parameters are utilized by the player to determine the audio data retrieval strategy.

In some embodiments the player does not understand about mphoa rendering, in other words the player is “dumb” in the sense that the logic in determining which HOA sources are required at which order is housed in the renderer.

The renderer 1007 can therefore be configured to request through the RendererStateInterface 1102 from the player HOA sources with the order that it requires them.

```
aligned(8) RendererStateInterface( ){
  unsigned int(8) renderType;//Type of rendering state information
  if(renderType==6DoFHOARendering)
    unsigned int(3) num_active_triangles;// Active triangles
    unsigned int(3) num_hoa_source_trr;//TRR list
    for(i=0; i<num_hoa_source_trr;i++){
      unsigned int(16) hoa_source_id;
      unsigned int(1) full_order_source;
      unsigned int(1) first_order_source;
    }
  }
  else if(renderType==ObjectRendering)
    /* Define for Object Rendering related state information*/
    for(i=0; i<num_object_sources;i++){
      unsigned int(16) object_source_id;
      unsigned int(1) object_source_culled;
      unsigned int(1) interactive_object_source;
      unsigned int(1) primary_render_item_active;
    }
  else
    /* Any other renderer scenario related state information*/
  }
}
```

| renderType value | Semantic description |
|---|---|
| 0 | Forbidden |
| 1 | 6DoF HOA rendering state |
| 2 | Object rendering |
| 3-255 | Reserved |

num_active_triangles can indicate the current number of active triangles considered in the renderer
num_hoa_source_trr can indicate the current number of HOA sources considered for active processing by the renderer
hoa_source_id can indicate the HOA source identifier of the HOA source in the TRR list.
full_order_source flag equal to 1 can indicate that the all channels of the HOA source is required by the renderer.
first_order_source equal to 1 can indicate that a first order HOA signal is required by the renderer for rendering for this HOA source.
num_object_sources indicates the number of object sources in the audio scene
object_source_id indicates the object source for which the retrieval hints are provided by the interface
interactive_object_source indicates the object source is interactive, consequently, it may be inactive but may be activated any moment by the user.
primary_render_item_active indicates the object source is an active primary render item and hence should be retrieved.

If more than one flag is set to 1 by the renderer via the interface, it is the player implementation choice to prioritize retrieval.

In some embodiments the Player does understand mphoa rendering. In other words the player is configured to understand what order of HOA sources is required based on the mphoa renderer scene state parameters.

```
aligned(8) RendererStateInterface( ){
  unsigned int(8) renderType;//Type of rendering state information
  if(renderType==6DoFHOARendering)
    unsigned int(3) num_active_triangles;// Active triangles
    unsigned int(3) num_hoa_source_trr;//TRR list
    for(i=0; i<num_hoa_source_trr;i++){
      unsigned int(16) hoa_source_id;
      unsigned int(1) signal_interpolation_source;
      unsigned int(1) beamforming_source;
      unsigned int(1) spatial_metadata_source;
    }
  }
  else if(renderType==ObjectRendering)
    /* Define for Object Rendering related state information*/
  else
    /* Any other renderer scenario related state information*/
  }
}
```

| renderType value | Semantic description |
|---|---|
| 0 | Forbidden |
| 1 | 6DoF HOA rendering state |
| 2 | Object rendering |
| 3-255 | Reserved |

num_active_triangles can indicate the current number of active triangles considered in the renderer
num_hoa_source_trr can indicate the current number of HOA sources considered for active processing by the renderer
hoa_source_id can indicate the HOA source identifier of the HOA source in the TRR list.
signal_interpolation_source flag equal to 1 can indicate that the HOA source is used for signal interpolation whereas a value equal to 0 indicates that it is not a signal interpolation source. A source used for spatial metadata processing is implicitly also used for spatial metadata interpolation.
beamforming_source flag equal to 1 can indicate that the HOA source is used for beamforming whereas a value equal to 0 indicates that it is not used for beamforming.
spatial_metadata_source equal to 1 can indicate that the HOA source is used for spatial metadata processing. A value equal to 0 indicates it is not used exclusively for spatial metadata processing.
The signal_interpolation_source and spatial_metadata_source can both be equal to 1 during a transition or change in the signal interpolation source.

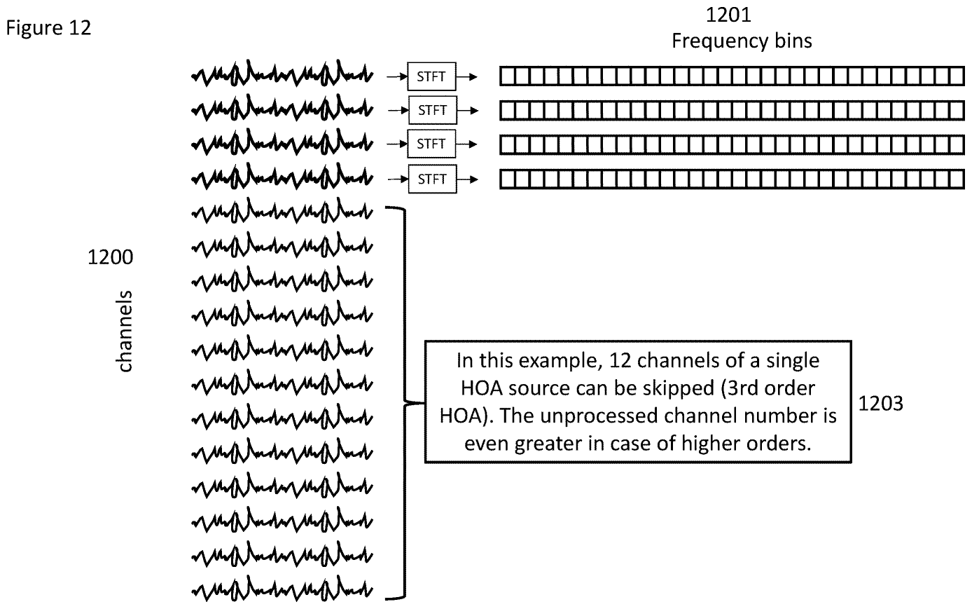

As shown in FIG. 12 this can result in a situation wherein only a subset of channels are processed (for example by a STFT), and the unprocessed channels are skipped to avoid wasteful retrieval of audio data.

Thus with respect to channels 1200 and frequency bins 1201 representing a HOA source there is shown a subset 1205 of channels representing the FOA channels which are processed by the STFT and the other 12 channels of a single HOA source are not processed or skip processing.

In some embodiments, such as described above where the decoder/player does understand mphoa rendering then the player receives listener position and and HOA source positions from the media manifest. Based on the listener position, the renderer can be configured to determine the relevant HOA sources for processing. These are determined by the renderer using the active triangle determination and the triangle track record (TRR). The player uses the RSI to obtain the HOA source(s) used for signal interpolation and the HOA source(s) used for spatial metadata processing.

In some embodiments, as an alternative to creating a media description that comprises first order HOA representation in addition to the full order HOA representation, the media description carries the full order HOA representation where the player decides to retrieve audio data corresponding to only the first order HOA channels for the HOA sources indicated by the RendererStateInterface( ). This can be implemented by performing an appropriate byte range request which retrieves only the audio data corresponding to the first four channels from the full order HOA representation.

In such implementations there is avoided generating the additional first order HOA representation and requires additional determination of the byte range information to be retrieved.

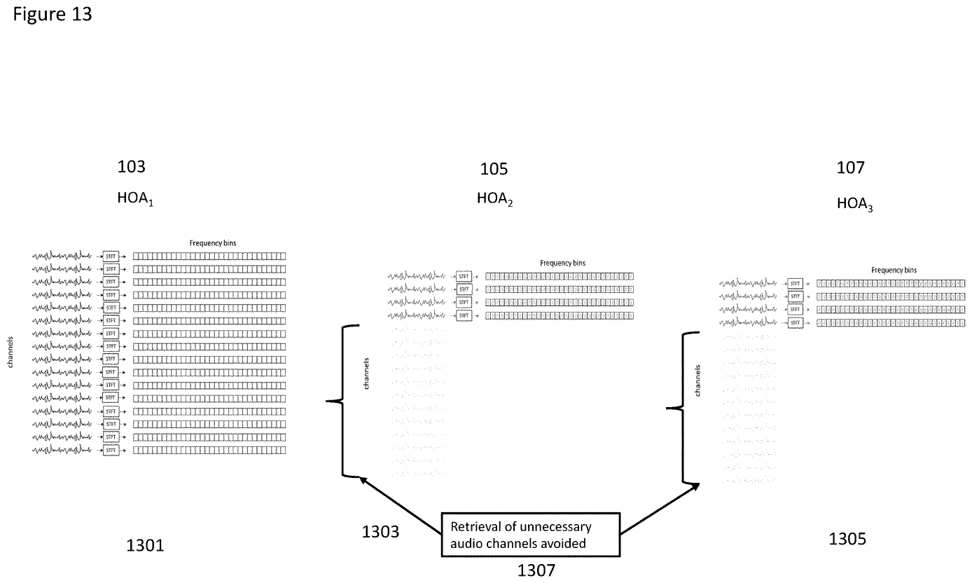

An example of which is shown in FIG. 13 which shows an example of the audio sources that are encoded/retrieved when a listener is in the audio scene as shown in FIG. 1 when the for the time between T₀ 151 and T₁ 153 in other words ΔT₁ 102. In this example is shown where the HOA audio source HOA₁ 103 has the full set 1301 of channels and frequency bins whereas where the HOA audio source HOA₂ 105 and the HOA audio source HOA₃ 107 has the sub-set 1303 and 1305 of channels and frequency bins. As such there is avoided the retrieval 1307 of unnecessary audio channels. In these embodiments, the player retrieves full order HOA representation from the media manifest for the HOA source which is used for signal interpolation and for HOA sources used for beamforming. Simultaneously, the decoder/player retrieves the first order HOA representation from the media manifest for the HOA source which is used for spatial metadata processing. The retrieved media is delivered to the MPEG-H 3DA decoder which passes the decoded PCM frame buffers to the MPEG-I Immersive audio renderer.

In some embodiments the decoder/player is configured to receive listener position and and HOA source positions from the media manifest. Based on the listener position, the renderer determines the relevant HOA sources for processing. These are determined by the renderer using the active triangle determination and the triangle track record (TRR). The player uses the RSI to obtain the list of HOA source(s) to be retrieved at which HOA order representation level. In an implementation embodiment, the RSI interface indicates the need for full order and first order representation to the player. The player retrieves full order and first order HOA representation from the media manifest. The retrieved media is delivered to the MPEG-H 3DA decoder which passes the decoded PCM frame buffers to the MPEG-I Immersive audio renderer.

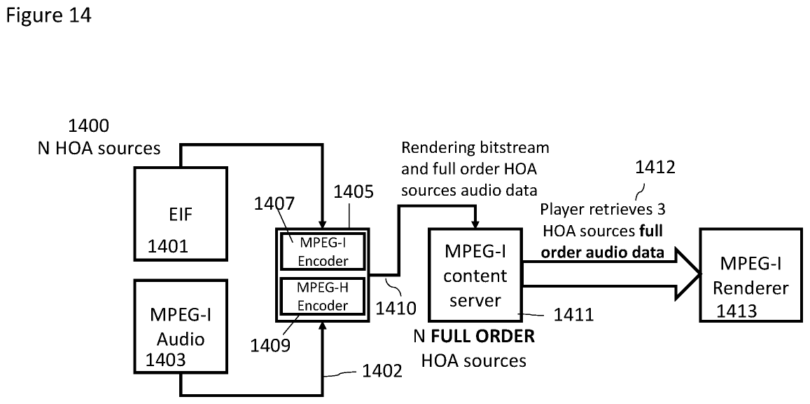

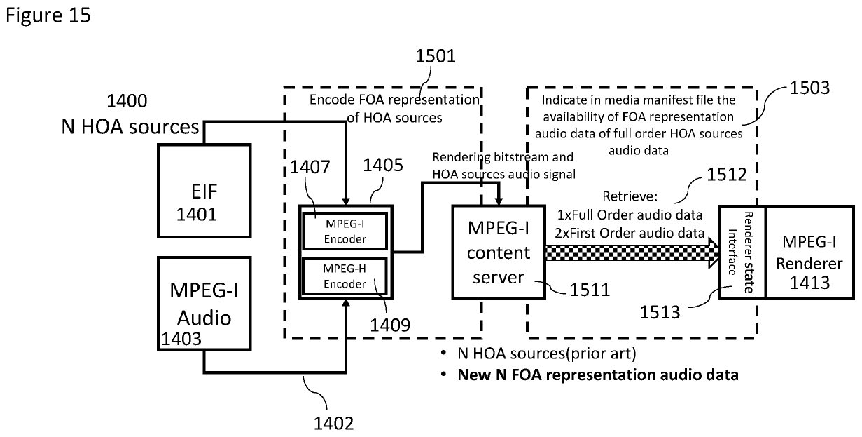

With respect to FIGS. 14 and 15 there is shown schematic views of the current implentations (shown with respect to FIG. 14) and the implementation according to some embodiments (shown with respect to FIG. 15).

Thus is shown with respect to FIG. 14 is the EIF source 1401 which is configured to provide N HOA sources 1400 to the encoder 1405. Also is shown a MPEG-I audio source 1403 configured to provide the MPEG-I audio signals 1402 also the encoder 1405.

The encoder 1405 comprises the MPEG-I encoder 1407 and the MPEG-H encoder 1409 which is configured to generate the bitstream 1410 to the MPEG-I content server 1411.

The MPEG-I content server 1411 is configured to store the N full order HOA sources. The decoder/player can then be configured to retrieve from the MPEG-I content server 1411 3 HOA sources full order audio data 1412 to the MPEG-renderer 1413.

With respect to FIG. 15 is then additionally shown that the encoder 1505 is configured to encode FOA representations of the HOA sources as shown by 1501. The MPEG-I content server 1511 is in these embodiments is configured to store both the N HOA sources and the new N FOA representation audio data.

The MPEG-I content server 1511 in these embodiments is configured to indicate 1503 in the media manifest file the availability of FOA representation audio data of full order HOA sources audio data.

In some embodiments the renderer state interface 1513 which is coupled to the MPEG-I renderer 1413 is configured and is configured to control the retrieval 1512 of 1× full order audio data and 2× first order audio data from the MPEG-I content server 1511.

The additional cost is in terms of generating additional HOA first order representation in DASH server (MPEG-I content).

In the following a scenario is described for audio data retrieval for 6DoF HOA rendering. As discussed earlier the most (redundant or wasteful) method is delivering all the HOA sources in the audio scene, for the entire duration of audio scene consumption. This is the least efficient.

An improvement over the all supply example is a method to deliver only the HOA sources that are required for 6DoF HOA rendering based on listener position in the audio scene.

The equation below describes the total delivery bitrate:

$$α = {\sum }_{i = 0}^{n} β$$

α=Total bitrate for delivering HOA sources for 6DoF HOA rendering.
β=Bitrate per HOA source
n=number of HOA sources delivered

In some embodiments different HOA order representations for a given HOA source in the audio scene are represented as Bⱼ, where j varies from 1 to 6 (for 1^{st} order HOA source up to 6^{th} order HOA source). The upper limit in this example is 6, because this is the highest order supported by MPEG-H 3DA (ISO/IEC 23080-3 3^{rd} edition).

The number of active HOA sources or HOA sources required for 6DoF HOA rendering at a given listener position can vary depending on various factors such as whether the one or more HOA sources encompassing a listener position to form a triangle are about to change or if the listener has performed a teleport operation which results in a jump in the listener position to a new set of HOA sources that are required for 6DoF HOA rendering.

An example for a common scenario is where a listener is within a triangle formed by 3 HOA sources for a period of more than a predefined threshold (e.g., 30 milliseconds derived from duration of six audio frames of 256 samples at 48000 Hz sampling rate), 3 HOA sources are considered as required for 6DoF HOA rendering. If we consider this scenario as the basis for benchmarking the required bitrate, following is the equation for describing the delivery bitrate with prior art or state of the art method:

$$α = 3 ⋆ {β}_{j} ( where j indicates the order of the delivered HOA source ) .$$

However, with the proposed method in these embodiments the following equation (for an equivalent scenario) provides:

$$α = 2 ⋆ {β}_{1} + {β}_{j} ( where j indicates the order of the delivered HOA source ) .$$

This results in significant bitrate savings without any loss of quality.

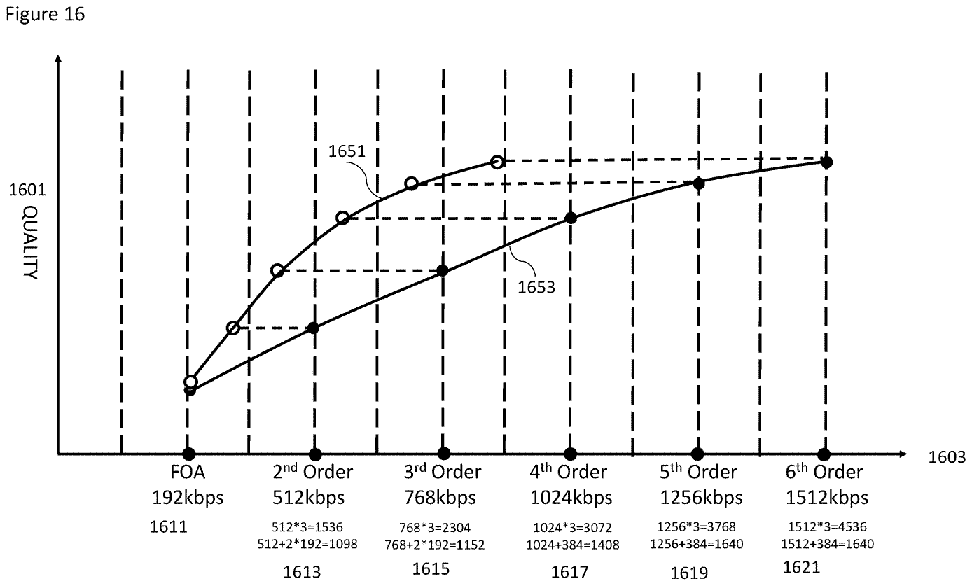

Thus the bitrate for delivering a HOA source at different orders is described in FIG. 16 which shoes quality 1601 vs various orders. Please note that the bitrate values for the different orders shown in FIG. 16 are examples, and can be decided based on content creator selection (depending on encoder implementation).

| | | Total bitrate with | |
|---|---|---|---|
| | | state of the art | |
| | Bitrate per | delivery in a | Total bitrate with differentiated |
| | HOA | typical case for | delivery based on role of HOA |
| HOA | source | 6DoF HOA | source for 6DoF HOA rendering |
| source | (kbps) | rendering (kbps) | (kbps) |
| order | βᵢ | 3*βᵢ | 2*β₁ + βᵢ |
| 1 | 256 | 768 | 768 |
| 2 | 384 | 1152 | 896 |
| 3 | 768 | 2304 | 1280 |
| 4 | 1024 | 3072 | 1536 |
| 5 | 1256 | 3768 | 1768 |
| 6 | 1512 | 4536 | 2024 |

In case of delivering HOA sources with current implementations and the proposed embodiments, it would be obvious that there is no benefit for the first order HOA source 1611 i.e. FOA. However, for higher orders 1613, 1615, 1617, 1619, 1621, the benefit increases significantly. As can be seen from the illustrated rate distortion curve as shown in FIG. 16 showing the bitrate savings increase for scenes with higher order HOA sources.

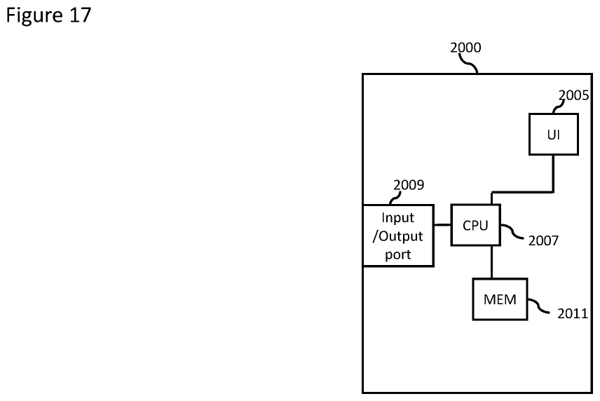

With respect to FIG. 17 an example electronic device which may be used as the computer, encoder processor, decoder processor or any of the functional blocks described herein is shown. The device may be any suitable electronics device or apparatus. For example in some embodiments the device 2000 is a mobile device, user equipment, tablet computer, computer, audio playback apparatus, etc.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 2009 may be configured to transmit/receive the audio signals, the bitstream and in some embodiments perform the operations and methods as described above by using the processor 2007 executing suitable code.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media, and optical media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method for generating an audio scene having at least two audio content sets, the method comprising:
obtaining a media description comprising information identifying positions of audio sources within the audio scene associated with the at least two audio content sets;
encoding the at least two audio content sets such that the at least two audio content sets are configured to be output at at least two representation levels; and
outputting for the audio scene encoded at least two audio content sets, wherein the output encoded at least two audio content sets comprises a first of the encoded at least two audio content sets encoded at a first of the at least two representation levels and a second first of the encoded at least two audio content sets encoded at a second of the at least two representation levels.

2. The method as claimed in claim 1, wherein the at least two audio content sets comprise at least one of:
at least two higher ambisonics audio sources; or
metadata associated with the at least two higher ambisonics audio sources.

3. (canceled)

4. The method as claimed in claim 2, wherein the metadata associated with the at least two higher order ambisonics audio sources comprises positions within the audio scene.

5. The method as claimed in claim 1, wherein the media description further comprises information identifying the at least two representation levels.

6. The method as claimed in claim 5, wherein the at least two representation levels comprise at least two from:
a full order representation of the at least two audio content sets;
a reduced or lower order representation of the at least two audio content sets; and
a first order representation of the at least two audio content sets.

7. The method as claimed in claim 6, wherein the full order representation of the at least two audio content sets comprises all channels of the at least two higher order ambisonics audio sources, the reduced or lower order representation of the at least two audio content sets is a selection of channels of the at least two higher order ambisonics audio sources, and the first order representation of the at least two audio content sets is a selection of first four channels of at least two higher order ambisonics audio sources.

8. The method as claimed in claim 1, wherein outputting for the audio scene encoded at least two audio content sets comprises:
receiving at least one request with respect to the audio scene, the request identifying a representation level for the at least two audio content sets;
selecting the encoded at least two audio content sets at the representation level for the at least two audio content sets identified within the at least one request; and
outputting the selected the encoded at least two audio content sets at the representation level for the at least two audio content sets identified within the at least one request.

9. The method as claimed in claim 1, wherein obtaining a media description comprising information identifying positions of audio sources within an audio environment associated with the at least two audio content sets further comprises outputting the media description to an apparatus, wherein the outputting for the audio scene encoded at least two audio content sets is further to the apparatus.

10. (canceled)

11. A method for generating an audio scene having at least two audio content sets, the method comprising:
obtaining a media description comprising information identifying positions of audio sources within the audio scene associated with the at least two audio content sets;
obtaining a listener position within the audio scene;
determining for the at least two audio content sets a source representation level based on the positions of the audio sources associated with the at least two content sets and the listener position;
retrieving encoded at least two audio content sets based on the source representation level, wherein the encoded at least two audio content sets comprise a first of the encoded at least two audio content sets encoded at a first of at least two representation levels and a second of the encoded at least two audio content sets encoded at a second of the at least two representation levels; and
generating spatialized audio output based on the retrieved encoded at least two audio content sets.

12. The method as claimed in claim 11, wherein the at least two representation levels comprise at least two of:
a full order representation of the at least two audio content sets;
a reduced or lower order representation of the at least two audio content sets; or
a first order representation of the at least two audio content sets.

13. The method as claimed in claim 11, wherein the media description further identifies an ambisonics order for the at least two audio content sets.

14. The method as claimed in claim 12, wherein retrieving encoded at least two audio content sets based on the source representation level comprises retrieving an encoded all channels representation for the encoded at least two audio content sets when the source representation level is the full order representation.

15. The method as claimed in claim 12, wherein retrieving encoded at least two audio content sets based on the source representation level comprises retrieving an encoded selected channels representation for the encoded at least two audio content sets when the source representation level is the reduced or lower order representation.

16. The method as claimed in claim 12, wherein retrieving encoded at least two audio content sets based on the source representation level comprises retrieving an encoded a first four selected channels representation for the encoded at least two audio content sets when the source representation level is the first order representation.

17. The method as claimed in claim 11, wherein generating the spatialized audio output based on the retrieved encoded at least two audio content sets comprises:
performing signal interpolation with processing channel signals of the retrieved encoded at least two audio content sets based on the listener position; and
generating the spatialized audio output based on the performed signal interpolation.

18. The method as claimed in claim 11, wherein retrieving encoded at least two audio content sets based on the source representation level comprises:
generating a request for representations of the encoded at least two audio content sets, the request comprising the source representation level; and
receiving the requested representations of the encoded at least two audio content sets.

19. The method as claimed in claim 11, wherein determining for the at least two audio content sets a source representation level based on the positions of the audio sources associated with the at least two content sets and the listener position further comprises determining content set rendering related state information associated with the at least two audio content sets, wherein retrieving encoded at least two audio content sets comprises retrieving encoded at least at least two audio content sets based on the content set rendering related state information.

20. The method as claimed in claim 19, wherein the content set rendering related state information configured to identify whether the content set is to be used is one of:
a six-degree of freedom higher order ambisonics audio source during generating the spatialized audio output; or
an object rendering audio source during generating the spatialized audio output.

21-22. (canceled)

23. An apparatus for generating an audio scene having at least two audio content sets, the apparatus comprising:
at least one processor; and
at least one memory storing instructions that, when executed with the at least one processor, cause the apparatus at least to:
obtain a media description comprising information identifying positions of audio sources within the audio scene associated with the at least two audio content sets;
encode the at least two audio content sets such that the at least two audio content sets are configured to be output at at least two representation levels; and
output for the audio scene encoded at least two audio content sets, wherein the output encoded at least two audio content sets comprises a first of the encoded at least two audio content sets encoded at a first of the at least two representation levels and a second first of the encoded at least two audio content sets encoded at a second of the at least two representation levels.

24. An apparatus for generating an audio scene having at least two audio content sets, the apparatus comprising:
at least one processor; and
at least one memory storing instructions that, when executed with the at least one processor, cause the apparatus at least to:
obtain a media description comprising information identifying positions of audio sources within the audio scene associated with the at least two audio content sets;
obtain listener position within the audio scene;
determine for the at least two audio content sets a source representation level based on the positions of the audio sources associated with the at least two content sets and the listener position;
retrieve encoded at least two audio content sets based on the source representation level, wherein the encoded at least two audio content sets comprise a first of the encoded at least two audio content sets encoded at a first of at least two representation levels and a second of the encoded at least two audio content sets encoded at a second of the at least two representation levels; and
generate spatialized audio output based on the retrieved encoded at least two audio content sets.
